(19) United States
(12) Patent Application Publication
(10) Pub. No.: US 2026/0337496 A1
(43) Pub. Date: Oct. 29, 2026

(54) GAS-SOLID CO-CURRENT DOWNFLOW FLUIDISED BED CATALYTIC CRACKING PROCESS WITH ORIENTED FEED INJECTOR

(71) Applicant: IFP Energies Nouvelles, Rueil-Malmaison (FR)

(72) Inventors: Sina TEBIANIAN, Rueil-Malmaison Cedex (FR); Thierry GAUTHIER, Rueil-Malmaison Cedex (FR); Jan VERSTRAETE, Rueil-Malmaison Cedex (FR)

(73) Assignee: IFP Energies Nouvelles, Rueil-Malmaison (FR)

(21) Appl. No.: 19/120,412

(22) PCT Filed: Oct. 2, 2023
(86) PCT No.: PCT/EP2023/077200

§ 371 Date: Apr. 11, 2025

(30) Foreign Application Priority Data
Oct. 13, 2022 (FR) FR2210518

(51) Int. Cl. C10G 11/18; B01J 8/18

(52) U.S. Cl. CPC C10G 11/18; B01J 8/1827; B01J 8/1881; B01J 2208/00769; B01J 2208/00938; C10G 2300/1037; C10G 2300/4006; C10G 2300/4012; C10G 2300/4018; C10G 2300/70

(57) ABSTRACT

Process for cocurrent gas-solid downflow fluid catalytic cracking, using: a vertical pipe (1) transporting a downward flow (4) of catalyst particles; a mixing chamber (2) comprising at least one first injector (5) for injecting hydrocarbon feedstock (6); a cocurrent gas-solid downflow fluidized bed reactor (3) fed with catalyst and hydrocarbon feedstock, the first injector having a predetermined angle α relative to the horizontal such that: the vector of the resultant momentum (Mₜₒₜ), vector sum of the feedstock momentum (M₆) and catalyst momentum (M₄), has an angle λ relative to a horizontal plane of 70°-80°; and the ratio of the vertical component of the feedstock momentum (M_{θv}) to the catalyst vertical and downward momentum is between −0.2 and 0.1.

### TECHNICAL FIELD

The invention relates to the field of refining and petrochemistry and processes and units for the chemical transformation of petroleum products, notably hydrocarbon cuts, by fluid catalytic cracking (FCC) for the production of light olefins (i.e. olefins comprising between 2 and 4 carbon atoms), and more particularly ethylene and propylene, and also aromatics (e.g. BTX), and more particularly para-xylene.

### PRIOR ART

The invention resides in improving the design of the established flow zone in cocurrent gas-solid downflow fluidized bed reactors (“downers” or “downflow reactors”), referred to hereinafter as downflow reactors, used for example for high severity catalytic cracking (HS-FCC).

Ethylene, propylene, butene, butadiene and aromatics such as benzene, toluene and xylene (BTX) represent the base products for the petrochemicals industry. These products are generally obtained by catalytic reforming and/or thermal cracking (steam cracking) of hydrocarbons such as naphtha, kerosene or gas oil. These compounds are also obtained by fluid catalytic cracking (FCC) of hydrocarbons, such as a vacuum distillate (VD, or VGO for vacuum gas oil) and/or a (vacuum or atmospheric) residue from the distillation of hydrocarbons and/or naphtha, gas oils, and whole crudes.

The high severity catalytic cracking (HS-FCC) process is aimed at increasing the yields of propylene and ethylene via high-temperature reaction conditions, very short contact times (e.g. ~1 s), and high ratios between the mass flow rate C of catalyst and the mass flow rate O of feedstock (C/O).

The disadvantages associated with a conventional cocurrent gas-solid upflow fluidized bed FCC reactor (or “riser”), such as backmixing and the accumulation of catalyst in the vicinity of the wall resulting in overcracking of the hydrocarbons and excessive formation of coke, hydrogen, methane and ethane, do not make it possible to promote the production of olefins under high severity conditions.

In order to overcome these disadvantages, the HS-FCC process uses a downflow reactor, in which the catalyst and the feedstock are set in motion under the effect of gravity with a flow that approximates that of plug flow. The downward gas-solid flow in a reactor avoids the backmixing and overcracking of the products, while the use of high C/O ratios ensures the predominance of the catalytic reactions. The high temperature promotes the formation of reaction intermediates such as light olefins, while a controlled and short contact time avoids the side reactions that are responsible for the consumption of such intermediates.

However, the downward gas-solid flow exhibits a number of major technological challenges, of which one significant challenge corresponds to the flow within the mixing chamber. This is because the initial mixing between the catalyst and the feedstock determines the vaporization of the hydrocarbons and the gas-solid contact throughout the downflow reactor. The initial mixing is generally performed in a fraction of a second with, for a typical HS-FCC, a flow rate of the order of 400 to 700 t/h of feedstock and 7000 to 21000 t/h of catalyst, which requires efficient technology in order to have a mixing chamber that approximates a perfectly stirred zone.

Patent FR 2 753 453 B1 describes a downflow cracking reactor comprising a zone for bringing the hydrocarbons into contact with the catalyst in which the injectors are oriented so as to direct droplets of feedstock countercurrent to the downward flow of catalyst particles, at an angle relative to the horizontal equal for example to 15°, but which may be between 2° and 45°.

### SUMMARY OF THE INVENTION

Within the above-described context, a first objective of the present invention is to overcome the problems of the prior art and to provide an apparatus for cocurrent gas-solid downflow fluid catalytic cracking with homogeneous catalyst flow, i.e. in which the concentration of solid in the cross section of the reactor is substantially uniform. Specifically, the apparatus according to the invention makes it possible to obtain a homogeneous catalyst concentration between the central zone and the annular zone (i.e. in the vicinity of the wall) of the cocurrent gas-solid downflow reactor.

A second objective of the present invention is to provide an apparatus for cocurrent gas-solid downflow fluid catalytic cracking in which the catalyst concentration in the central zone is higher with less accumulation near the walls in the mixing chamber, which results in better contact with the vaporized feedstock.

A third objective of the present invention is to provide an apparatus for cocurrent gas-solid downflow fluid catalytic cracking in which the arrangement of the injectors is optimized according to the C/O ratio.

According to a first aspect, the abovementioned objectives, along with other advantages, are achieved by an apparatus for cocurrent gas-solid downflow fluid catalytic cracking comprising, from top to bottom:
a pipe suitable for transporting a downward flow of catalyst particles;
a mixing chamber connected to the pipe and suitable for being fed via the pipe with a downward flow, the mixing chamber comprising at least one first injector for injecting hydrocarbon feedstock; and
a cocurrent gas-solid downflow fluidized bed reactor connected to the mixing chamber and suitable for being fed by the mixing chamber with a mixture comprising catalyst particles and hydrocarbon feedstock,
wherein the at least one first injector has a predetermined angle α relative to the horizontal which meets the following two criteria:
the vector of the resultant momentum, calculated from the vector sum of the feedstock momentum and the catalyst momentum, has an angle A relative to a horizontal plane of between 70° and 80°; and
the ratio of the vertical component of the feedstock momentum to the catalyst momentum is between −0.2 and 0.1.

Advantageously, the apparatus makes it possible to homogenize the concentration of catalyst particles along the fluidized bed reactor. Advantageously, the apparatus makes it possible to improve the contact between the catalyst and the vaporized feedstock. Advantageously, the apparatus makes it possible to optimize the arrangement and orientation of the injectors according to the operating conditions envisaged.

According to one or more embodiments, the mixing chamber comprises between 2 and 12 first injectors, preferably between 3 and 8 first injectors.

According to one or more embodiments, the vector of the resultant momentum has an angle A relative to a horizontal plane of between 72° and 77°; and/or the ratio of the vertical component of the feedstock momentum to the catalyst momentum is between −0.13 and 0.04.

According to one or more embodiments, the first injectors are arranged countercurrent to the downward flow at an angle α of between 15° and 45° relative to the horizontal.

According to one or more embodiments, at least one first injector has an orientation that is off-axis, relative to the diameter of the mixing chamber, by an angle θ of greater than 0° and less than or equal to 45°, and preferably of between 10° and 20°.

According to one or more embodiments, first injectors are arranged in one or more horizontal rows.

According to one or more embodiments, the mixing chamber comprises at least one second injector for injecting diluent.

According to one or more embodiments, the second injectors have an angle β relative to the horizontal of between 0° and 80°, and preferably of between 10° and 45°.

According to one or more embodiments, second injectors are arranged in one or more horizontal rows.

According to one or more embodiments, the radial position of the second injectors is in a separation space between the adjacent radial positions of two first injectors.

According to one or more embodiments, the radial position of at least one second injector is arranged relative to the radial position of an adjacent first injector at an angle δ substantially equal to half of the separation angle γ between two adjacent first injectors.

According to one or more embodiments, at least one second injector has an orientation that is off-axis, relative to the diameter of the mixing chamber, by an angle δ of greater than 0° and less than or equal to 45°, and preferably of between 10° and 20°.

According to one or more embodiments, at least one part of the mixing chamber comprises a central plug arranged substantially along a central/vertical axis of the mixing chamber and defining an annular orifice in the mixing chamber, through which the catalyst particles discharge and/or flow into the mixing chamber.

According to a second aspect, the abovementioned objectives, along with other advantages, are achieved by a process for cocurrent gas-solid downflow fluid catalytic cracking, comprising the following steps:
transporting a downward flow of catalyst particles in a (vertical) pipe;
feeding a mixing chamber via the (vertical) pipe with the downward flow, the mixing chamber comprising at least one first injector for injecting hydrocarbon feedstock;
feeding a cocurrent gas-solid downflow fluidized bed reactor via the mixing chamber with a mixture comprising catalyst particles and hydrocarbon feedstock; and
at least partially cracking the hydrocarbon feedstock in the presence of the catalyst particles in the cocurrent gas-solid downflow fluidized bed reactor, in order to produce an effluent comprising at least partially coked catalyst and gaseous cracking products,
wherein the at least one first injector has a predetermined angle α relative to the horizontal which meets the following two criteria:
the vector of the resultant momentum, calculated from the vector sum of the feedstock momentum and the catalyst (vertical and downward) momentum, has an angle A relative to a horizontal plane of between 70° and 80°; and
the ratio of the vertical component of the feedstock momentum to the catalyst (vertical and downward) momentum is between −0.2 and 0.1.

According to one or more embodiments, the process comprises at least one of the following operating conditions:
the catalyst particles comprise a matrix made of clay, silica or silica alumina, optionally of binder, optionally of dopant, and/or of zeolite, for example from 15% to 70% by weight of zeolite relative to the weight of the catalyst, preferably a zeolite Y and/or a zeolite ZSM-5, very preferably a zeolite ZSM-5, which is optionally doped;
the grain density of the catalyst particles is between 1000 kg/m³ and 2000 kg/m³, preferably between 1250 kg/m³ and 1750 kg/m³;
the hydrocarbon feedstock is a hydrocarbon feedstock with an initial boiling point above or equal to 340 °C or a hydrocarbon feedstock with a final boiling point below or equal to 450 °C;
the downward flow of catalyst particles in the (vertical) pipe upstream of the mixing chamber is in dense fluidized regime, preferably with a mass flow of greater than 200 kg/m²s;
reactor outlet temperature of between 520 °C and 750 °C and preferably below 650 °C;
absolute total pressure of between 0.1 MPa and 0.5 MPa;
mass ratio of catalyst to hydrocarbon feedstock, C/O, of between 5 (kg/h)/(kg/h) and 35 (kg/h)/(kg/h) and preferably between 15 (kg/h)/(kg/h) and 30 (kg/h)/(kg/h);
contact time tc between the hydrocarbon feedstock and the catalyst of less than 10 seconds, preferably between 0.5 seconds and 4 seconds;
mass flow of catalyst particles of between 50 and 850 kg/(m²s), preferably between 400 and 750 kg/(m²s);
superficial gas velocity of between 2 m/s and 26 m/s, preferably between 6 m/s and 16 m/s;
injection of diluent by the first injector and/or at least one second injector in an amount representing 0% or 0.1% to 40% by weight, preferably 1% to 35% by weight and preferably between 1% and 30% by weight relative to the mass of hydrocarbon feedstock.

Other features and advantages of the invention of the aforementioned aspects will become apparent on reading the following description of non-limiting exemplary embodiments, with reference to the appended figures described below.

### LIST OF THE FIGURES

FIG. 1 represents a cross-sectional diagram of an FCC apparatus according to one or more embodiments of the present invention comprising injectors for homogenization of the catalyst flow.

FIG. 2 shows a diagram and a cross-sectional view showing the fluid flow in the mixing chamber of an FCC apparatus according to one or more embodiments of the present invention.

FIG. 3 shows a schematic top view of the mixing chamber of an FCC apparatus according to one or more embodiments of the present invention.

FIG. 4 shows 3D views of an FCC apparatus according to one or more embodiments of the present invention.

FIG. 5 shows 3D views of a layout A of a reference FCC apparatus, and of a layout B of an FCC apparatus according to one or more embodiments of the present invention.

FIG. 6 shows 3D views of layouts A and B of the volume fraction of the catalyst averaged over time in the reference FCC apparatus of FIG. 5, and in the FCC apparatus according to the invention of FIG. 5, respectively.

FIG. 7 shows the radial profiles A and B of the fraction of the solid and mass flow of the solid at 2.8 m below the injectors of the reference FCC apparatus of FIG. 5, and of the FCC apparatus of the invention of FIG. 5, respectively.

### DETAILED DESCRIPTION OF THE INVENTION

Embodiments according to the aforementioned aspects will now be described in detail. The following detailed description discloses numerous specific details in order to provide a deeper understanding of the apparatus and process according to the present invention. However, it will be apparent to those skilled in the art that the apparatus can be implemented without these specific details. In other cases, well-known characteristics have not been described in detail in order to avoid unnecessarily complicating the description.

In the present description, the term “comprise” is synonymous with (means the same thing as) “have”, “include” and “contain”, and is inclusive or open-ended and does not exclude other elements that are not stated. It is understood that the term “to comprise” includes the exclusive and closed term “to consist of”. In addition, in the present description, the terms “essentially” or “substantially” or “approximately” correspond to an approximation of ±10%, preferably of ±5%, very preferably of ±1%.

The invention relates to an apparatus and to a process for fluid catalytic cracking for the chemical transformation of petroleum products (FCC), used for example for high severity catalytic cracking (HS-FCC).

An FCC unit generally treats a (so-called heavy) hydrocarbon cut obtained from the vacuum distillation unit, such as a vacuum gas oil or a vacuum residue, or else an atmospheric residue, alone or as a mixture. An FCC unit can also treat (so-called light) hydrocarbon cut such as a gasoline cut or a gas oil cut, alone or as a mixture. It is also possible to treat a mixture of light and heavy hydrocarbon cuts, or else a whole crude. In order to increase the propylene and ethylene yields by using high severity reaction conditions (high temperature, very short contact times, high C/O ratios between the flow rate C of catalyst and the flow rate O of feedstock), the catalytic cracking apparatuses and processes generally use a cocurrent gas-solid downflow fluidized bed reactor (“downer” or “downflow reactor”), hereinafter referred to as a downflow reactor.

However, the downward gas-solid flow may exhibit a number of technological challenges, including achieving homogeneous flow and mixing in the established flow section of the downflow reactor.

In order to overcome these disadvantages, improvements to the downflow reactor technology described in the patent FR 2 753 453 B1 have been identified in order to respond to the challenge set out above, by way of a specific arrangement of hydrocarbon feedstock injectors, and optionally diluent injectors, to improve the contact between the catalyst and the hydrocarbons in the mixing chamber.

### The Apparatus According to the Invention

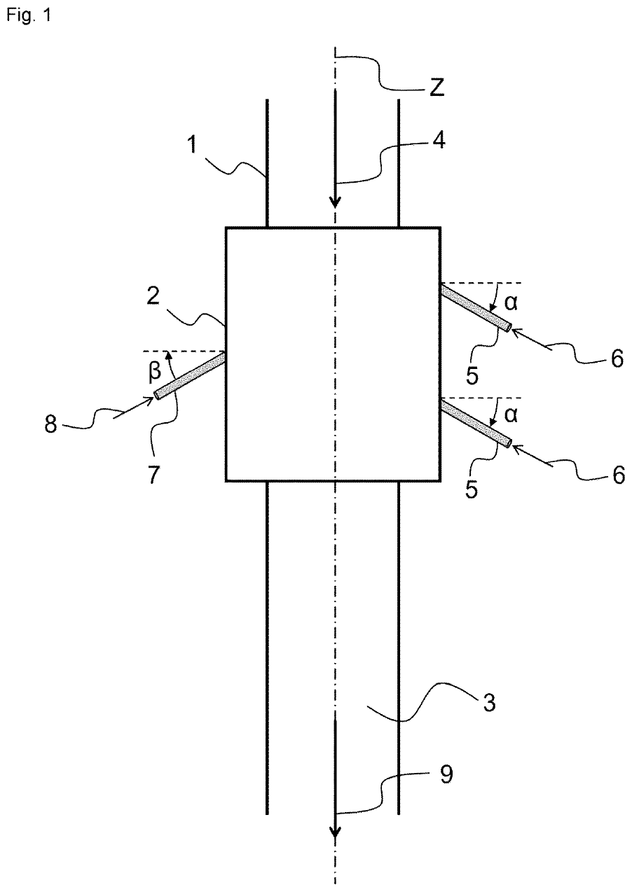

With reference to FIG. 1, the apparatus according to one or more embodiments of the present invention comprises, from top to bottom:
a (substantially vertical) pipe 1;
a mixing chamber 2; and
a (substantially vertical) downflow reactor 3.

The pipe 1 is suitable for feeding the mixing chamber 2 with solid catalyst (particles). The pipe 1 mainly transports solid, and also a fluidizing gas entrained by the downward flowing solid. The pipe 1 has a flow like a standpipe, well known to those skilled in the art.

The mixing chamber 2 is connected to the pipe 1 and is suitable for feeding the downflow reactor 3 with a mixture comprising catalyst particles, a hydrocarbon feedstock and optionally a diluent.

The downflow reactor 3 is connected to the mixing chamber 2 and is suitable for at least partially cracking the hydrocarbon feedstock in the presence of the catalyst particles in order to produce an effluent comprising at least partially coked catalyst and gaseous cracking products, and optionally unconverted vaporized feedstock.

Specifically, with reference to FIG. 1, the pipe 1 feeds the mixing chamber 2 with a downward flow 4 of (hot) catalyst particles, the mixing chamber 2 comprising one or more first injectors 5 for injecting hydrocarbon feedstock 6. According to one or more embodiments, the first injector(s) 5 is/are suitable for injecting diluent (e.g. steam) with the feedstock. According to one or more embodiments, the mixing chamber 2 comprises one or more second injectors 7 for injecting diluent 8. In the mixing chamber 2, the downward flow 4 comes into contact with the hydrocarbon feedstock 6 atomized by means of the first injector(s) 5 and optionally with diluent 8 introduced for example by the second injector(s) 7.

Advantageously, the injection of diluent 8 makes it possible to reduce the partial pressure of the hydrocarbon feedstock and to reduce side reactions. Advantageously, the injection of diluent 8 makes it possible to improve the atomization of the hydrocarbon feedstock 6. According to one or more embodiments, the diluent 8 is chosen from the group consisting of steam, nitrogen, CO₂, light hydrocarbons (e.g. C1-C5 compounds) and combustion flue gases. According to one or more embodiments, the diluent 8 comprises or consists of steam.

According to one or more embodiments, the pipe 1 has a geometry with a constant cross section, such as cylindrical, square, rectangular or hexagonal, or with a variable cross section, such as truncated pyramidal or frustoconical, or a combination of the various geometrical forms. According to one or more embodiments, the pipe 1 is cylindrical in form and optionally of variable diameter. According to one or more embodiments, the pipe 1 is at least partially frustoconical in form. According to one or more embodiments, the pipe 1 comprises (in the direction of flow of the solid catalyst): a cylindrical portion, the diameter of which is for example chosen in order to obtain a flow of solid of 100 to 800 kg/(m²s) and preferably between 300 to 600 kg/(m²s); a frustoconical (“narrowing”) portion adjacent to the mixing chamber 2, the diameter of which decreases, for example in order to achieve a flow of solid, without taking the internals into account, of between 400 and 2000 kg/(m²s) and preferably between 700 and 1500 kg/(m²s); and optionally a second cylindrical portion, the diameter of which is for example chosen in order to obtain a flow of solid, without taking the internals into account, of between 400 and 2000 kg/(m²s) and preferably between 700 and 1500 kg/(m²s).

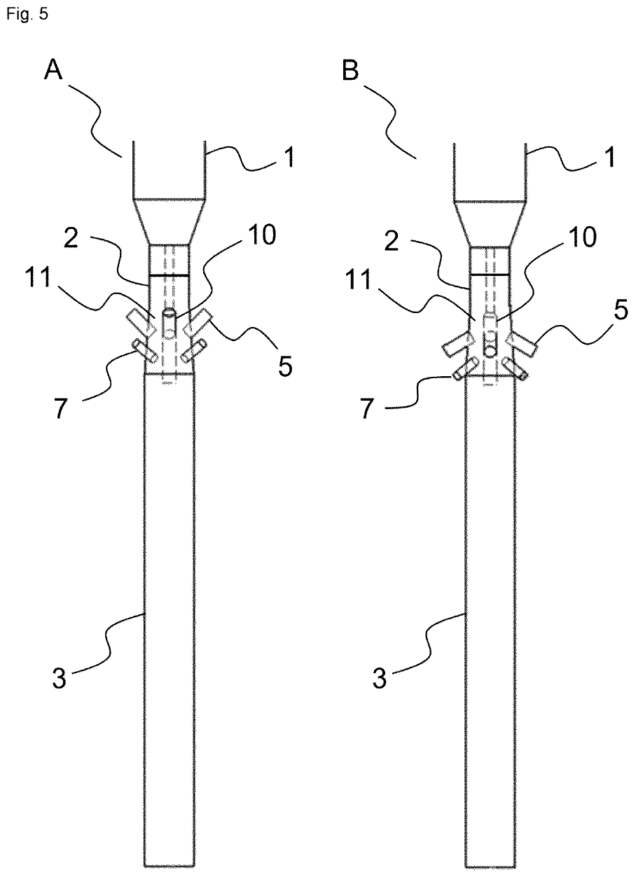

According to one or more embodiments, the mixing chamber 2 has a geometry with a constant cross section, such as cylindrical, square, rectangular or hexagonal, or with a variable cross section, such as truncated pyrimidal or frustoconical, or a combination of the various geometrical forms. The mixing chamber may be provided with central internals, such as a central plug described below with reference to FIG. 5. According to one or more embodiments, the mixing chamber 2 is cylindrical in form and optionally of variable diameter. According to one or more embodiments, the mixing chamber 2 is at least partially frustoconical in form. According to one or more embodiments, the mixing chamber 2 comprises an upper cross-sectional boundary S1 connecting the mixing chamber 2 to the pipe 1 and a lower cross-sectional boundary S2 connecting the mixing chamber 2 to the downflow reactor 3, the ratio S1/S2 being less than 0.9 and preferably less than 0.7. According to one or more embodiments, the ratio S1/S2 is between 0.4 and 0.9, preferably between 0.5 and 0.7.

According to one or more embodiments, the mixing chamber 2 comprises between 2 and 12 first injectors 5, preferably between 3 and 8 first injectors 5.

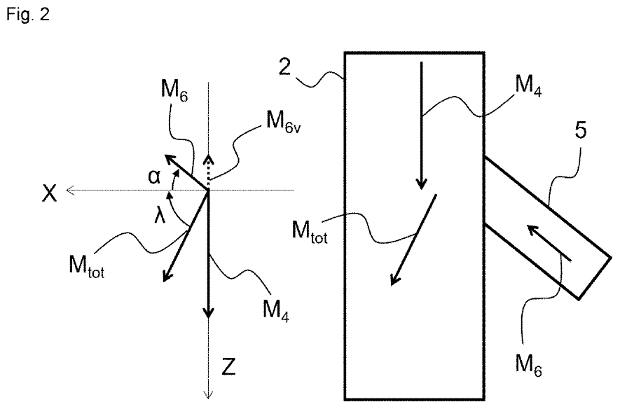

With reference to FIGS. 1 and 2, the applicant has identified that the axial direction of the first injectors 5 is a key element for dispersing the catalyst well. Specifically, according to the invention, the first injectors 5 have a predetermined angle α (alpha) relative to the horizontal which meets the following two criteria:
the vector of the resultant momentum Mₜₒₜ, calculated from the vector sum of the feedstock momentum (defined as mass (or mass flow)*velocity) M₆ and the catalyst momentum M₄, has an angle λ (lambda) relative to the horizontal of between 70° and 80° and preferably between 72° and 77°; and
the ratio of the vertical component of the vector of the feedstock momentum M₆ᵥ to the catalyst momentum M₄ is between −0.2 and 0.1, and preferably between −0.13 and 0.04.

Meeting the two criteria mainly gives axial directions of the first injectors 5 countercurrent to the downward flow 4, for example at an angle α of between 0° and 80°, or slightly cocurrent with the downward flow 4, for example at an angle α of between −20° and 0°. According to one or more embodiments, the first injectors 5 are arranged countercurrent to the downward flow 4 at an angle α of between 15° and 45° relative to the horizontal.

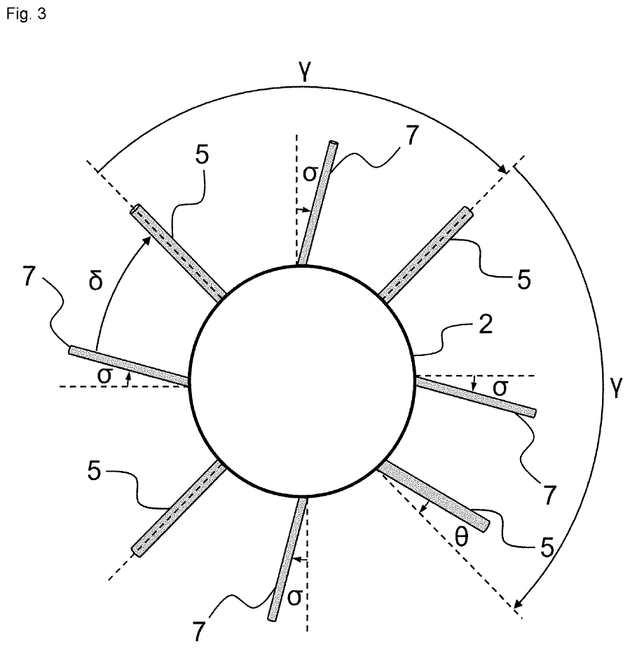

In addition, with reference to FIG. 3, in order to promote turbulence in the mixing chamber 2 and direct the feedstock toward zones with a higher concentration of catalyst, at least one first injector 5 can have an orientation (in a projection on a horizontal plane) that is off-axis relative to the diameter of the mixing chamber 2 by an angle θ (theta) of greater than 0° and less than or equal to 45°, and preferably of between 10° and 20°. According to one or more embodiments, adjacent off-axis first injectors 5 have respectively positive and negative e angles, in particular to improve turbulence.

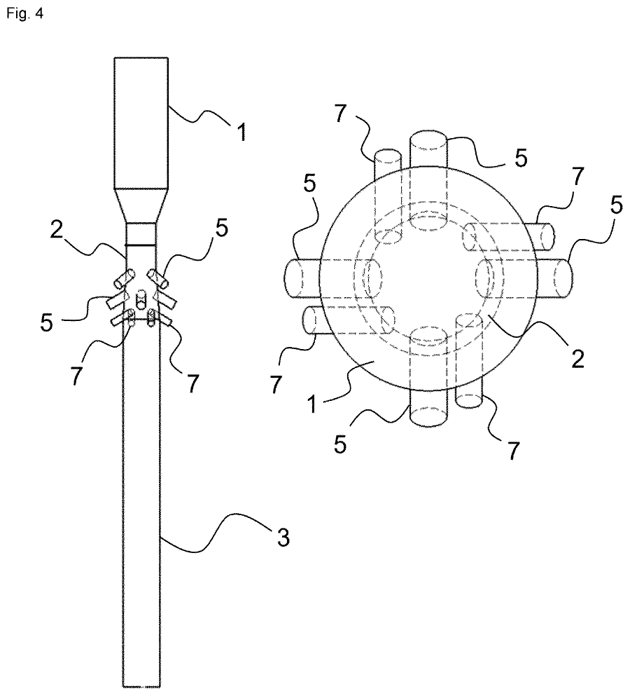

With reference to FIG. 4, according to one or more embodiments, first injectors 5 are arranged in one or more horizontal rows, i.e. perpendicular to the central/vertical axis Z of the pipe 1, of the mixing chamber 2 and of the downflow reactor 3. According to one or more embodiments, the adjacent first injectors 5 of one row of first injectors 5 are arranged on the wall of the mixing chamber 2 at a separation angle γ (gamma) that is substantially equal to 360° divided by the number of first injectors 5 of said row.

According to one or more embodiments, the mixing chamber 2 comprises between 2 and 12 second injectors 7, preferably between 3 and 8 second injectors 7.

With reference to FIG. 1, the second injectors 7 have an angle β (beta) relative to the horizontal of between 0° and 80°, and preferably between 10° and 45°.

With reference to FIG. 4, according to one or more embodiments, second injectors 7 are arranged in one or more horizontal rows (perpendicular to the central/vertical axis Z).

With reference to FIG. 4, according to one or more embodiments, second injectors 7 are arranged below (for example, a row of) first injectors 5. According to one or more embodiments, second injectors 7 are arranged between two rows of first injectors 5.

With reference to FIGS. 3 and 4, according to one or more embodiments, the radial position of second injectors 7 is in a separation space between the adjacent radial positions of two first injectors 5. According to one or more embodiments, the radial position of at least one second injector 7 is arranged relative to the radial position of an adjacent first injector 5 a second injector 7 (in a projection on a horizontal plane) at an angle δ (delta) substantially equal to half of the separation angle γ between two adjacent first injectors 5.

With reference to FIGS. 3 and 4, in order to promote turbulence in the mixing chamber 2 and direct the catalyst toward zones with a higher concentration of feedstock, the second injectors 7 can have an orientation (in a projection on a horizontal plane) that is off-axis relative to the diameter of the mixing chamber by an angle δ (sigma) of greater than 0° and less than or equal to 45°, and preferably of between 10° and 20°. To make the top view of FIG. 4 clearer, a row of injectors 5 has been deleted.

With reference to FIG. 1, the mixing chamber 2 feeds the downflow reactor 3 with a mixture of hydrocarbon feedstock 6, catalyst particles and optionally diluent 8. Advantageously, the hydrocarbon feedstock 6 and the catalyst particles give rise to cracking reactions which are completed in the downflow reactor 3 of height L (along the central/vertical axis Z) to produce a hydrocarbon effluent 9 comprising cracking products, spent catalyst and potentially a portion of the hydrocarbon feedstock that has not reacted.

With reference to FIG. 5, according to one or more embodiments, at least one part of the mixing chamber 2 comprises a central plug 10 arranged substantially along the central/vertical axis Z and defining an annular orifice 11 in the mixing chamber 2, through which the catalyst particles discharge and/or flow into the mixing chamber 2.

According to one or more embodiments, the vertical position of the first injectors 5 and/or of the second injectors 7 is between the top end and the bottom end of the central plug 10, i.e. the feedstock 6 and optionally the diluent 8 are introduced into the annular orifice 11 of the mixing chamber 2.

According to one or more embodiments, the downflow reactor 3 has a geometry with a constant cross section, such as cylindrical, square, rectangular or hexagonal, and preferably cylindrical. According to one or more embodiments, the downflow reactor 3 is cylindrical in form and optionally of variable diameter. According to one or more embodiments, the diameter of the downflow reactor 3 is defined such that the superficial velocity of the gas passing through it is between 2 m/s and 26 m/s, preferentially between 6 m/s and 16 m/s.

### The Catalyst

The catalyst is a solid catalyst (e.g. particles with a density, size and shape of the grains chosen for use in a fluidized bed). The densities, sizes and shapes of the catalysts for fluidized beds are known to a person skilled in the art and will not be described further. The catalyst may be any type of catalytic cracking catalyst.

According to one or more embodiments, the catalyst is an FCC catalyst, containing, for example, what is commonly called a matrix made of clay, of silica or of silica-alumina, optionally of binder, and/or of zeolite, for example from 15% to 70% by weight of zeolite relative to the weight of the catalyst, preferably a zeolite Y and/or a zeolite ZSM-5. According to one or more embodiments, the catalyst comprises a zeolite ZSM-5. According to one or more embodiments, the grain density of the catalyst is between 1000 kg/m³ and 2000 kg/m³. According to one or more embodiments, the grain density of the catalyst is between 1250 kg/m³ and 1750 kg/m³.

According to one or more embodiments, the catalyst comprises at least one binder (e.g. from 30% to 85% by weight) chosen from alumina, silica, silica-alumina, magnesia, titanium oxide, zirconia, clays and boron oxide, alone or in a mixture, and preferably from silica, silica-alumina and clays, alone or in a mixture.

According to one or more embodiments, the catalyst comprises at least one doping element (e.g. from 0 to 10% by weight) chosen from phosphorus, magnesium, sodium, potassium, calcium, iron, boron, manganese, lanthanum, cerium, titanium, tungsten, molybdenum, copper, zirconium and gallium, alone or in a mixture.

According to one or more embodiments, the catalyst comprises and/or consists of zeolite, such as ZSM-5, which is optionally doped.

### The Feedstock

According to one or more embodiments, the hydrocarbon feedstock 6 is a (so-called heavy) hydrocarbon feedstock, characterized by an initial boiling point of substantially 340 °C, or even above 340 °C, often above 380 °C, such as a heavy hydrocarbon cut, for example obtained from a vacuum distillation unit, such as vacuum gas oil (VGO)/vacuum distillate or a vacuum residue, an atmospheric residue, vacuum gas oil obtained from a conversion unit, such as a coker gas oil (heavy coker gas oil (HCGO)) or a heavy hydrocarbon cut obtained from an ebullated bed or entrained bed hydroconversion unit (such as H-Oil, LC-Fining, EST, VCC or Uniflex processes), a recycle stream from a hydrocracking step, alone or as a mixture.

According to one or more embodiments, the hydrocarbon feedstock 6 is a so-called light feedstock, characterized by a final boiling point below or equal to 450 °C, often below 400 °C, such as a gasoline cut or a gas oil cut, for example obtained from an atmospheric distillation unit, or obtained from a conversion unit, such as a gasoline or a gas oil from a hydrocracking unit, or a gasoline or a gas oil from a coking unit or a gasoline or a gas oil from an ebullated bed or entrained bed hydroconversion unit (such as H-Oil, LC-Fining, EST, VCC or Uniflex processes), or a gasoline or a gas oil obtained from an FCC unit, or a recycle stream from the FCC unit concerned, alone or as a mixture. According to one or more embodiments, it is also possible to treat a mixture of light and heavy hydrocarbon cuts, or else a whole crude.

On contact with the downward flow 4 of hot catalyst particles, the atomized hydrocarbon feedstock 6 vaporizes and endothermic cracking reactions take place along the downflow reactor 3, thus reducing the temperature and producing:
upgradable products (e.g. C1-C4 gas comprising olefins; a gasoline cut comprising aromatics);
optionally a light gas oil cut (light cycle oil (LCO));
optionally a heavy gas oil cut (heavy cycle oil (HCO));
optionally an oil in the form of slurry; and
optionally a solid residue (coke) adsorbed on the catalyst.

### The Process According to the Invention

The process according to the present invention comprises a catalytic cracking stage for the production of light olefins (and in particular ethylene and propylene), aromatics (and in particular benzene, toluene and xylenes), and gasoline (and optionally LCO, HCO and slurry), by catalytic cracking of the hydrocarbon feedstock 6 (fed via the first injector 5) through contact with the downward flow 4 of hot catalyst particles (fed via the pipe 1), and optionally the diluent 8 (fed via the second injector 7) in the mixing chamber 2 and then in the downflow reactor 3.

According to one or more embodiments, the downward flow 4 of the catalyst particles in the pipe 1 upstream of the mixing chamber 2 is in dense fluidized regime, preferably with a mass flow of greater than 200 kg/m²s, in order for example to preferably enable a regime with descending bubbles.

In the present patent application, the term “dense fluidized bed” means a gas-solid fluidized bed operating in homogeneous regime, in bubbling regime or in turbulent regime.

In the present patent application, the term “homogeneous fluidized bed” means a gas-solid fluidized bed, the gas velocity of which is between the minimum fluidization velocity and the minimum bubbling velocity. These velocities depend on the properties of the solid catalyst (density, size, shape of the grains, etc.). The volume fraction of solid is between a value close to 0.45 and the maximum volume fraction of solid corresponding to a non-fluidized fixed bed, generally close to 0.6.

In the present patent application, the term “bubbling fluidized bed” means a gas-solid fluidized bed, the gas velocity of which is between the minimum bubbling velocity and the velocity of transition to turbulent regime. These velocities depend on the properties of the solid catalyst (density, size, shape of the grains, etc.). The volume fraction of solid is between a value close to 0.35 and a value close to 0.45.

In the present patent application, the term “turbulent fluidized bed” means a gas-solid fluidized bed, the gas velocity of which is between the velocity of transition to turbulent regime and the transport velocity. The volume fraction of solid is between a value close to 0.25 and a value close to 0.35.

In the present patent application, the term “transport fluidized bed” means a gas-solid fluidized bed, the gas velocity of which is greater than the transport velocity. The volume fraction of solid is less than a value close to 0.25. In the present patent application, the term “transport velocity” corresponds to the velocity with which essentially all the solid is entrained by the gas.

According to one or more embodiments, the injectors 5 are suitable for atomizing the hydrocarbon feedstock 6 (liquid) and penetrating the catalyst stream.

According to one or more embodiments, the operating conditions of the pipe 1 and/or of the downflow reactor 3 are chosen from the following conditions:
temperature (of reactor outlet) of between 520 °C and 750 °C and preferably below 650 °C;
absolute total pressure of between 0.1 MPa and 0.5 MPa;
weight ratio of catalyst 4 to hydrocarbon feedstock 6, C/O, of between 5 (kg/h)/(kg/h) and 35 (kg/h)/(kg/h) and preferably between 15 (kg/h)/(kg/h) and 30 (kg/h)/(kg/h);
contact time t_{c} between the hydrocarbon feedstock 6 and the catalyst of less than 10 seconds, preferably between 0.5 seconds and 4 seconds;
mass flow of catalyst particles of between 50 and 850 kg/(m²s), preferably between 400 and 750 kg/(m²s); and
superficial gas velocity of between 2 m/s and 26 m/s, preferably between 6 m/s and 16 m/s.

In the present description, the contact time t_{c} is defined as the product of the solid volume fraction εₛ and the bed height Hₛ (e.g. reactor height L), divided by the superficial gas velocity sgv, this being integrated along the height of the bed, as defined below in the mathematical formula Math 1.

$${t}_{c} = {\int }_{0}^{{H}_{s}} \frac{{ε}_{s} {H}_{s}}{sgv} \qquad Math 1$$

According to one or more embodiments, an amount of diluent 8 (e.g. nitrogen and/or steam) is added to the feedstock to reduce the partial pressure of hydrocarbons in the feedstock and the diluent is introduced in an amount representing 0% or 0.1% to 40% by weight, preferably 1% to 35% by weight and preferably between 1% and 30% by weight relative to the mass of hydrocarbon feedstock 6.

According to one or more embodiments, at the end of the catalytic cracking step in the downflow reactor 3, the gaseous products and the catalyst, and optionally the unconverted vaporized feedstock, are separated in the gas/solid separator (not shown) containing a dense fluidized bed where the cracking reactions can continue.

According to one or more embodiments, the operating conditions of the separator are chosen from the following conditions:
temperature (of reactor outlet) of between 500 °C and 750 °C, preferably between 550 °C and 700 °C, and even more preferably between 580 °C and 685 °C;
absolute total pressure of between 0.1 MPa and 0.5 MPa and preferably between 0.1 MPa and 0.4 MPa and with preference between 0.1 MPa and 0.3 MPa;
weight ratio of catalyst to feedstock (unconverted vaporized feedstock and gaseous products), C/O, of between 5 (kg/h)/(kg/h) and 40 (kg/h)/(kg/h);
contact time t_{c} between the feedstock and the catalyst of between 500 milliseconds (ms) and 10 seconds; and
partial pressure of the hydrocarbons in the feedstock (PPHfeedstock) of between 0.01 MPa and 0.3 MPa, preferably between 0.02 MPa and 0.2 MPa and with preference between 0.05 MPa and 0.15 MPa.

According to one or more embodiments, at the outlet of the separator, the coked catalyst is sent to an optional stripper (not shown) in order to strip the hydrocarbons that have remained adsorbed on the surface of the catalyst by means of a second diluent.

According to one or more embodiments, the operating conditions of the stripper are chosen from the following conditions:
residence time of the catalyst in the stripper: between 10 seconds and 180 seconds, preferentially between 30 seconds and 120 seconds;
superficial gas velocity between the minimum fluidization velocity and the velocity of transition to the turbulent regime, for example between 0.01 m/s and 0.5 m/s, preferentially between 0.15 m/s and 0.4 m/s;
solid flow between 25 kg/m²s and 200 kg/m²s, preferentially between 50 kg/m²s and 150 kg/m²s and preferably between 50 kg/m²s and 100 kg/m²s;
temperature between 500 °C and 750 °C, preferentially between 550 °C and 650 °C;
absolute total pressure of between 0.1 MPa and 0.5 MPa and preferably between 0.1 MPa and 0.4 MPa and with preference between 0.1 MPa and 0.3 MPa;
solid volume fraction between 0.25 and 0.6, preferentially between 0.4 and 0.6.

According to one or more embodiments, at the outlet of the separator or stripper, the coked solid is transported to a regenerator (not shown) in which an air supply burns the coke off the catalyst to produce hot regenerated catalyst and combustion gases, it being possible for the hot regenerated catalyst to feed the downward flow 4 with hot catalyst particles.

According to one or more embodiments, the operating conditions of the regenerator are chosen from the following conditions:
superficial gas velocity between 0.1 m/s and 2 m/s, preferentially between 0.2 m/s and 1.5 m/s;
residence time of the catalyst of between 30 seconds and 20 minutes, preferentially between 1 minute and 10 minutes;
temperature between 500 °C and 840 °C, preferentially between 650 °C and 750 °C.

### EXAMPLES

With reference to FIG. 5, the flows in a reference apparatus A and an apparatus according to the invention B operating under non-reactive conditions were compared in order to study the hydrodynamics.

The reference apparatus A comprises:
a pipe 1, composed of a cylindrical portion, a narrowing cone and a cylindrical portion;
a frustoconical mixing chamber 2 (S1/S2 being less than 1) comprising a central plug 10 defining an annular orifice 11;
a cylindrical downflow reactor 3 having a length of 4.07 m and an internal diameter of 0.42 m;
four first injectors 5 for injecting hydrocarbon feedstock 6, positioned cocurrent with the downward flow 4 of catalyst particles with a downward angle of 45° relative to the horizontal direction, which produces an angle A of the vector of the resultant momentum Mₜₒₜ of 79° relative to the horizontal. The ratio of the vertical component of the feedstock momentum M₆ᵥ to the catalyst momentum M₄ is 0.23 which is outside the recommended range; and
four second injectors 7 for injecting diluent 8 (steam), positioned cocurrent to the downward flow 4 of catalyst particles with an downward angle of 45° relative to the horizontal direction.

The apparatus according to the invention B comprises:
a pipe 1, composed of a cylindrical portion, a narrowing cone and a cylindrical portion;
a frustoconical mixing chamber 2 (S1/S2 being less than 1) comprising a central plug 10 defining an annular orifice 11;
a cylindrical downflow reactor 3 having a length of 4.07 m and an internal diameter of 0.42 m;
four first injectors 5 for injecting hydrocarbon feedstock 6, positioned countercurrent to the downward flow 3 of catalyst particles with an upward angle α of 30° relative to the horizontal direction, which produces an angle A of the vector of the resultant momentum Mₜₒₜ of 72° relative to the horizontal. The ratio of the vertical component of the feedstock momentum M₆ᵥ to the catalyst momentum M₄ is −0.16; and
four second injectors 7 for injecting diluent 8 (steam), positioned countercurrent to the downward flow 3 of catalyst particles with an upward angle β of 30° relative to the horizontal direction.

The configurations of the reference apparatus A and of the apparatus according to the invention B were simulated in CFD with the Barracuda© tool under the following operating conditions:
the catalyst flow is 607 kg/m²s;
the catalyst has a diameter d₅₀ of 73 μm and a grain density of 1418 kg/m³ (i.e., group A of the Geldart classification);
the air flow rate of 1.85 kg/s exhibits a ratio of the first injectors 5 to the second injectors 7 of 70/30;
the first injectors 5 are positioned 0.2 m above the second injectors 7;
the angle δ of rotation between the first injectors 5 and the second injectors 7 is 45°;
the gas velocity at the outlet of the injectors is 90 m/s for the first injectors 5 and 76 m/s for the second injectors 7;
the flow is under ambient non-reactive conditions;
a central plug 10 is positioned at the center of the mixing chamber 2.

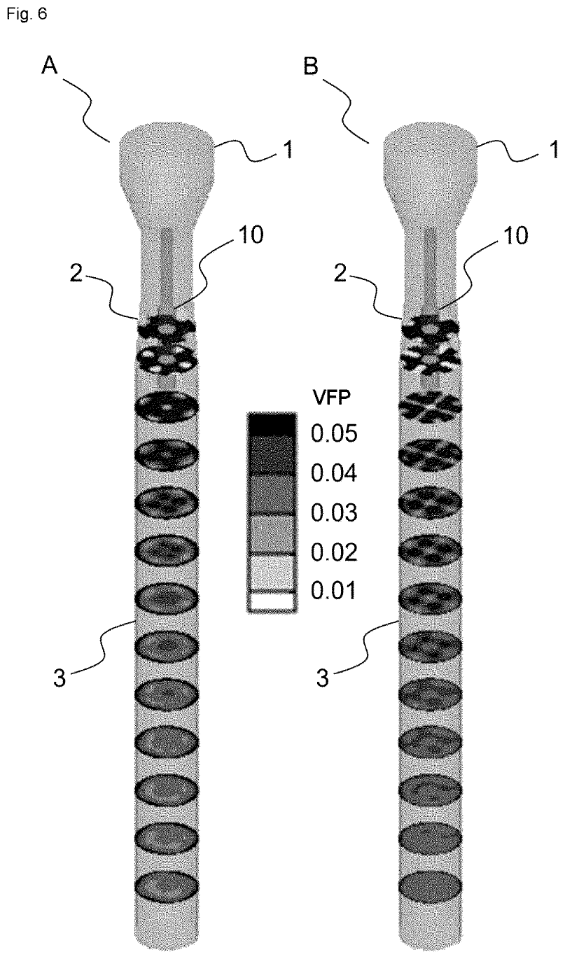

FIG. 6 presents the volume fraction of particles, denoted VFP, for the two configurations A and B of the reference apparatus A and of the apparatus according to the invention B, respectively, over 13 cross sections. The first two cross sections are respectively at the height of the first and second injectors 5 and 7, and the following cross sections are spaced 0.35 m apart.

Advantageously, the radial distribution of the solid throughout the downflow reactor 3 is always more homogeneous for the apparatus according to the invention B compared to the reference apparatus A. In addition, a high concentration of the solid in the vicinity of the wall can be noted for the reference apparatus A compared to the apparatus according to the invention B.

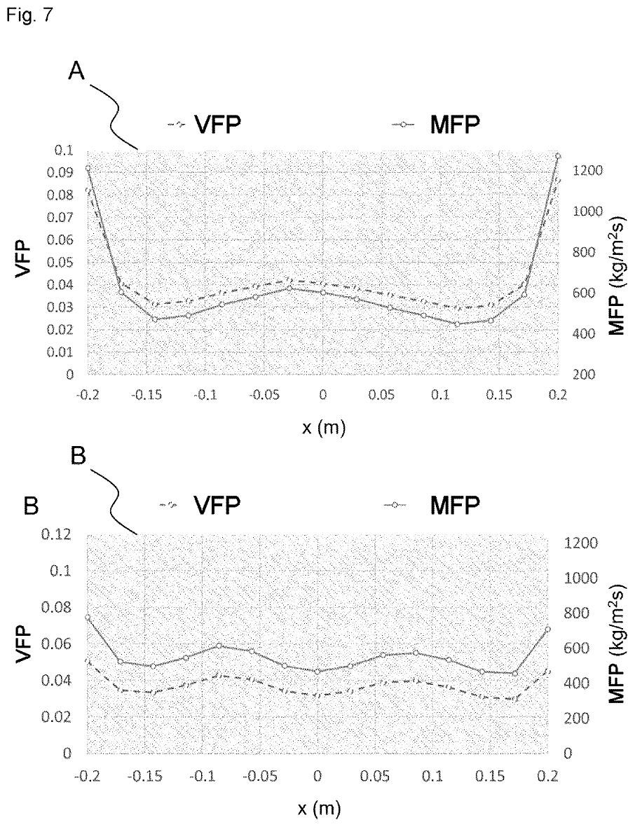

FIG. 7 shows the radial profiles A and B of the volume fraction of particles VFP, and of the mass flow of the particles, denoted MFP, of the reference apparatus A and of the apparatus according to the invention B of FIG. 5, respectively. The radial profiles A and B are produced in an x direction (perpendicular to the central/vertical axis Z) at a height of 2.8 m below the first injectors 5. It may be noted that the apparatus according to the invention B produces a more homogeneous radial profile B with a better phase distribution. The coefficient of variation of the values of volume fraction of particles VFP on these radial profiles A and B is 40% for the reference apparatus A and 15% for the apparatus according to invention B. Equivalently, the coefficient of variation of the values of mass flow of particles MFP for the profiles A and B is 59% for the reference apparatus A and 16% for the apparatus according to the invention B, which indicates a better dispersion of the catalyst over the cross section for the apparatus according to the invention B.

1. A process for cocurrent gas-solid downflow fluid catalytic cracking, comprising the following steps:
transporting a downward flow (4) of catalyst particles in a vertical pipe (1);
feeding a mixing chamber (2) via the vertical pipe (1) with a downward flow (4), the mixing chamber (2) comprising at least one first injector (5) for injecting hydrocarbon feedstock (6);
feeding a cocurrent gas-solid downflow fluidized bed reactor (3) via the mixing chamber (2) with a mixture comprising catalyst particles and hydrocarbon feedstock; and
at least partially cracking the hydrocarbon feedstock (6) in the presence of the catalyst particles in the cocurrent gas-solid downflow fluidized bed reactor (3), to produce an effluent (9) comprising at least partially coked catalyst and gaseous cracking products;
wherein the at least one first injector (5) has a predetermined angle α relative to the horizontal which meets the following two criteria:
the vector of the resultant momentum (Mₜₒₜ), calculated from the vector sum of the feedstock momentum (M₆) and the vertical and downward catalyst momentum (M₄), has an angle λ relative to a horizontal plane of between 70° and 80°; and
the ratio of the vertical component of the feedstock momentum (M₆ᵥ) to the catalyst vertical and downward momentum (M₄) is between −0.2 and 0.1.

2. The process as claimed in claim 1, wherein the mixing chamber (2) comprises between 2 and 12 first injectors (5).

3. The process as claimed in claim 1, wherein the vector of the resultant momentum (Mₜₒₜ) has an angle λ relative to a horizontal plane of between 72° and 77°; and/or the ratio of the vertical component of the feedstock momentum (M₆ᵥ) to the catalyst vertical and downward momentum (M₄) is between −0.13 and 0.04.

4. The process as claimed in claim 1, wherein the first injectors (5) are arranged countercurrent to the downward flow (4) at an angle α of between 15° and 45° relative to the horizontal.

5. The process as claimed in claim 1, wherein at least one first injector (5) has an orientation that is off-axis, relative to the diameter of the mixing chamber (2), by an angle θ of greater than 0° and less than or equal to 45°, and preferably of between 10° and 20°.

6. The process as claimed in claim 1, wherein first injectors (5) are arranged in one or more horizontal rows.

7. The process as claimed claim 1, wherein the mixing chamber (2) comprises at least one second injector (7) for injecting diluent (8).

8. The process as claimed in claim 7, wherein the second injectors (7) are arranged countercurrent to the downward flow (4) and have an angle β relative to the horizontal of between 0° and 80°.

9. The process as claimed in claim 7, wherein second injectors (7) are arranged in one or more horizontal rows.

10. The process as claimed in claim 7, wherein the radial position of the second injectors (7) is in a separation space between the adjacent radial positions of two first injectors (5).

11. The process as claimed in claim 7, wherein the radial position of at least one second injector (7) is arranged relative to the radial position of an adjacent first injector (5) at an angle δ substantially equal to half of the separation angle γ between two adjacent first injectors (5).

12. The process as claimed in claim 7, wherein at least one second injector (5) has an orientation that is off-axis, relative to the diameter of the mixing chamber (2), by an angle δ of greater than 0° and less than or equal to 45°.

13. The process as claimed in claim 1, wherein at least one part of the mixing chamber (2) comprises a central plug (10) arranged substantially along a central/vertical axis (Z) of the mixing chamber (2) and defining an annular orifice (11) in the mixing chamber (2), through which the catalyst particles discharge and/or flow into the mixing chamber (2).

14. The process as claimed in claim 1, comprising at least one of the following operating conditions:
the catalyst particles comprise a matrix made of clay, silica or silica alumina, optionally of binder, optionally of dopant, and/or zeolite;
the grain density of the catalyst particles is between 1000 kg/m³ and 2000 kg/m³,
the hydrocarbon feedstock (6) is a hydrocarbon feedstock with an initial boiling point above or equal to 340 °C or a hydrocarbon feedstock with a final boiling point below or equal to 450 °C;
the downward flow (4) of catalyst particles in the vertical pipe (1) upstream of the mixing chamber (2) is in dense fluidized regime;
reactor outlet temperature of between 520 °C and 750 °C;
absolute total pressure of between 0.1 MPa and 0.5 MPa;
mass ratio of catalyst (4) to hydrocarbon feedstock (6), C/O, of between 5 (kg/h)/(kg/h) and 35 (kg/h)/(kg/h);
contact time tc between the hydrocarbon feedstock (6) and the catalyst of less than 10 seconds;
mass flow of catalyst particles of between 50 and 850 kg/(m²s);
superficial gas velocity of between 2 m/s and 26 m/s;
injection of diluent (8) by the first injector (5) and/or at least one second injector (7) in an amount representing 0% or 0.1% to 40% by weight relative to the mass of hydrocarbon feedstock (6).

15. The process as claimed in claim 1, wherein the mixing chamber (2) comprises between 3 and 8 first injectors (5).

16. The process as claimed in claim 7, wherein the second injectors (7) are arranged countercurrent to the downward flow (4) and have an angle β relative to the horizontal of between 10° and 45°.

17. The process as claimed in claim 7, wherein at least one second injector (5) has an orientation that is off-axis, relative to the diameter of the mixing chamber (2), by an angle σ of between 10° and 20°.

19. The process as claimed in claim 14, wherein the catalyst particles comprise from 15% to 70% by weight of zeolite relative to the weight of the catalyst.

20. The process as claimed in claim 14, wherein
the grain density of the catalyst particles is between 1250 kg/m³ and 1750 kg/m³;
reactor outlet temperature is below 650 °C;
mass ratio of catalyst (4) to hydrocarbon feedstock (6), C/O, is between 15 (kg/h)/(kg/h) and 30 (kg/h)/(kg/h);
contact time tc between the hydrocarbon feedstock (6) and the catalyst is between 0.5 seconds and 4 seconds;
mass flow of catalyst particles is between 400 and 750 kg/(m²s);
superficial gas velocity is between 6 m/s and 16 m/s; and
injection of diluent (8) by the first injector (5) and/or at least one second injector (7) is in an amount representing 1% to 35% by weight relative to the mass of hydrocarbon feedstock (6).
